(19) United States
(12) Patent Application Publication
(10) Pub. No.: US 2026/0311033 A1
(43) Pub. Date: Oct. 8, 2026

(54) System and Method for Pre-Training Artificial Intelligence Network

(71) Applicant: Centre for Intelligent Multidimensional Data Analysis Limited, Pak Shek Kok (HK)

(72) Inventors: Xueke Tong, Pak Shek Kok (HK); Hong Yan, Pak Shek Kok (HK)

(21) Appl. No.: 19/090,569

(22) Filed: Mar. 26, 2025

(51) Int. Cl. G06N 20/00

(52) U.S. Cl. CPC G06N 20/00

(57) ABSTRACT

A system for training an Artificial Intelligence Model over a training dataset. The system includes a processor configured to execute instructions; and a computer-readable medium containing instructions for execution on the processor. The instructions are adapted to cause the processor to perform steps of: partitioning the training dataset into a plurality of strata according to class labels, wherein each stratum represents a single label; creating a subset data by selecting samples from each of the strata; training the AI Model using the subset data until a first halting condition is reached; and training the AI Mode using the training data set until a second halting condition is reached.

### TECHNICAL FIELD

This application relates to the field of artificial intelligence and provides a method and system for pre-training an artificial intelligence network. In particular, the present invention provides an efficient subset pre-training system and method that reduces deep network model training time.

### BACKGROUND

Neural networks, inspired by the human brain's architecture, originated in the late 1950s and early 1960s with Frank Rosenblatt's perceptrons or neurons. They have evolved significantly, becoming crucial in modern Artificial Intelligence (AI) for pattern recognition, data classification, and predictions through interconnected neural layers of nodes (neurons).

Neural networks are typically structured in a series of layers comprising an input layer, multiple hidden layers, and an output layer. Each neuron within these layers processes incoming signals using an activation function, such as ReLU (Rectified Linear Unit) or sigmoid, and transmits the resultant output to subsequent layers. The interconnections between neurons are characterized by parameters-namely weights and biases-which are iteratively fine-tuned during the training phase via optimization algorithms like gradient descent. This iterative process involves minimizing the network's prediction error, thereby enhancing the model's performance.

The training process aims to generalize the network to accurately recognize patterns and make reliable predictions on previously unseen data. This ensures the model's robustness and adaptability in practical applications. The optimization of these parameters is critical for the network to learn the underlying data distribution and achieve high accuracy in its predictions.

The progression of artificial neural networks from simple perceptrons or neurons to advanced deep learning frameworks has been characterized by significant advancements in computational methodologies. The advent of the backpropagation algorithm has allowed multilayer networks to optimize intricate functions, leading to breakthroughs such as convolutional neural networks (CNNs) for image processing and recurrent neural networks (RNNs) for sequential data analysis. Although the emergence of deep learning has enabled the creation of networks with numerous layers (deep networks) capable of surpassing traditional machine learning techniques, the training of these deep learning models remains computationally demanding when the training data size large, necessitating significant resources such as Graphics Processing Units (GPUs) or Tensor Processing Units (TPUs).

Limited by high-performance computational resources, deep learning will take extended training time which can hinder the adoption of deep learning technologies, particularly for smaller entities or individual researchers with limited computational power, or in scenarios requiring immediate responses, such as real-time systems. Furthermore, challenges in model training, such as overfitting, underfitting, and vanishing/exploding gradient issues, persist. For instance, traditional CNNs demonstrate impressive performance in many image classification tasks but encounter vanishing gradient problems as networks become deeper, complicating the training of very deep models effectively.

As deep network technology continues to advance, many revolutionary approaches have been introduced to overcome the difficulties encountered in training deep learning. Among them, one prior art is ResNet architectures with residual connections (or skip connections, shortcut connections). It allows gradients to flow through the network more easily during training and mitigates the degradation problem in deep networks, enabling the training of very deep networks efficiently and enhancing the prediction accuracy of networks. Moreover, residual connections could also be regarded as a form of regularization, helping to reduce overfitting and make the network more robust. Another advanced type of deep network, DenseNet (Densely Connected Network), uses concatenation to connect each layer to all preceding layers, resulting in a concatenated set of feature maps. It enhances feature reuse, which improves the flow of information and gradients across the network.

In recent years, various techniques have been developed to reduce the training time in deep neural networks (ResNet, DenseNet, etc.), addressing modern models' increasing complexity and size. These methods can be broadly categorized into pretraining optimizations (such as transfer learning, and knowledge distillation), training-time optimizations (such as batch normalization, network model pruning, learning rate adjustment, parallel and distributed training, early stopping, etc.), and alternative learning paradigms (such as curriculum learning). All pretraining and training-time optimizations above are applied for processing the complete training data directly as a whole, while curriculum learning involves training on easier examples first before progressing to more complex ones.

In one prior art, the determination and selection of “easier examples”, and “more complex ones” are associated with the test error criteria of networks. This approach does not greatly provide significant improvement in the training time and accuracy. Therefore, a better training method for the AI model is required to improve the efficiency of machine learning.

### SUMMARY OF THE INVENTION

According to a first aspect of the present invention, there is provided a method for subset pre-training procedure for reducing the overall training time of deep neural networks.

According to one aspect of the present invention, there is provided a system for training an artificial intelligence model over a training dataset comprising:
a processor configured to execute instructions;
a computer-readable medium containing instructions for execution on the processor, the instructions causing the processor to perform steps of:
partitioning the training dataset into a plurality of strata according to class labels, wherein each stratum represents a single label;
creating a subset data by selecting samples from each of the strata;
training the AI Model using the subset data until a first halting condition is reached; and
training the AI Mode using the training data set until a second halting condition is reached.

In a preferred embodiment, the subset data is created by selecting a predetermined percent α of samples from each stratum

In a preferred embodiment, the subset data is created by selecting random samples from each stratum.

In a preferred embodiment, the subset data is created by selecting samples based on informative ranking of samples in each stratum.

In a preferred embodiment, the subset data is created by selecting samples based on ascending informative ranking.

In a preferred embodiment, the subset data is created by selecting samples based on descending informative ranking.

In a preferred embodiment, the informative ranking of samples in each stratum is determined by the steps of:
converting samples in each stratum into vectors and then organized to form the matrix Xⁱ;
performing QR pivoting decomposition method to rearrange columns of Xⁱ to obtain a matrix

$${X}_{⋮ , p}^{i} ,$$

such that XP=QR or X_{:,p}=QR wherein P is a permutation matrix, Q is an orthogonal matrix, R is an upper triangular matrix, a first column X_{:,p(1)} of X_{:,p} is the most informative column and last column X_{:,p(|D|)} is the least informative column.

In a preferred embodiment, the permutation matrix P is chosen such that the diagonal elements of R are non-increasing: r₁₁≥r₂₂≥ . . . , ≥rₙₙ and P is a square binary matrix,

In a preferred embodiment, the data matrix X for image recognition is associated with Sobel edge detection.

In a preferred embodiment, he data matrix X for image recognition is associated with Gabor filter.

In a preferred embodiment, the first halting condition is reached when the AL Model has reached maximum epochs.

In a preferred embodiment, the second halting condition is reached when the AL

Model has reached a convergence threshold.

In a preferred embodiment, the percent α is between 10% to 50%.

In a preferred embodiment, the percent α is between 20% to 30%.

In a preferred embodiment, the AI Model is a deep learning artificial neural network model.

In a preferred embodiment, the deep learning artificial neural network model is a Residual Network (ResNet).

In a preferred embodiment, the deep learning artificial neural network model is a Densely Connected Network model (DenseNet).

In a preferred embodiment, the step of training the AI Model comprises the step of minimizing the loss function [symbol] over the subset, such that

$$ℒ ( S ) = \frac{1}{\vert S \vert} {\sum }_{x ∈ S} ℒ ( f ( x ; θ ) , y )$$

wherein f(x; θ) is model's prediction, y is true label, [symbol] denotes the loss function being optimized, and θ represents the model parameters.

In a preferred embodiment, the step of training the AI Model comprises the step of updating the model model parameters.

In a preferred embodiment, the model parameters comprise weights or biases of neuron nodes.

In a preferred embodiment, the steps of training the AI Model comprises the step of selecting samples of the subset data based on the QR factorization with column pivoting and then use an entire full dataset as the training data set.

In a preferred embodiment, the subset data is selected progressively from 20% to 100% for training adaptively based on size of an entire full dataset,

### BRIEF DESCRIPTION OF THE DRAWINGS

Embodiments of the present invention will now be described, by way of example, with reference to the accompanying drawings in which:

FIG. 1 is a schematic diagram of a computer system to implement the method for pre-training artificial intelligence network in accordance with an embodiment of the present invention.

FIG. 2 is a diagram showing the process flow of the method for pre-training artificial intelligence network in accordance with an embodiment of the present invention.

FIG. 3 is a schematic diagram of a system for pre-training artificial intelligence network to carry out the process of FIG. 2 in accordance with an embodiment of the present invention.

### DETAILED DESCRIPTION OF THE PREFERRED EMBODIMENT

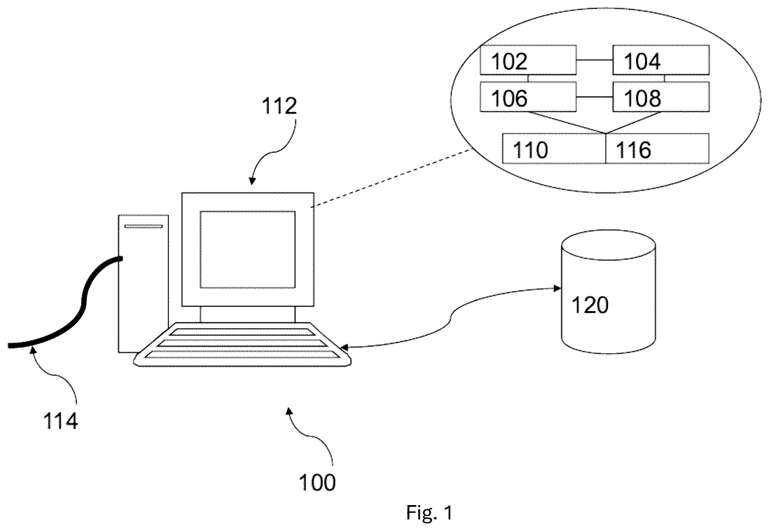

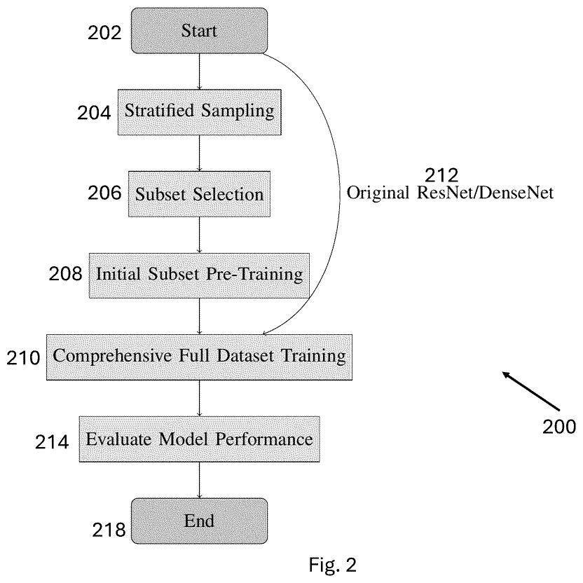

With reference to FIGS. 1 and 2, an embodiment of the present invention is illustrated. This embodiment is arranged to provide a system and method for pre-training an artificial intelligence network. The present invention provides an efficient subset pre-training method and system that reduces deep network model training time.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IoT) devices, edge computing devices, client/server architecture, “dumb” terminal/mainframe architecture, cloud-computing based architecture, or any other appropriate architecture. The computing device may be appropriately programmed to implement the invention.

Turning to FIG. 1, there is provided a schematic diagram of a computer system or server 100 to implement a system for efficient subset pre-training that reduces deep network model training time of an artificial intelligence system in accordance with an embodiment of the present invention.

This embodiment comprises a server 100 which includes suitable components necessary to receive, store and execute appropriate computer instructions. The components may include a processing unit 102, including Central Processing Units (CPUs), Math Co-Processing Unit (Math Processor), Graphic Processing Unit (GPUs), Neural Processing Unit (NPUs) or Tensor Processing Units (TPUs) for tensor or multidimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114 may also be present. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communication links may be connected to an external computing network through a telephone line or other type of communication links.

The server 100 may also include storage devices such as a disk drive 108 which may encompass solid state drives, hard disk drives, optical drives, magnetic tape drives or remote or cloud-based storage devices. The server 100 may use a single disk drive or multiple disk drives, or a remote storage service. The server 100 may also have a suitable operating system 116 which resides on the disk drive or in the ROM of the server 100.

In one embodiment of the present invention, there is provided a novel subset pre-training method for reducing the overall training time of deep neural networks (classical ResNet and DenseNet architectures) while maintaining accuracy on the testing dataset.

The method provided by the present invention focuses solely on the subset selection of training data which can be seamlessly integrated with various machine learning techniques, including pre-training strategies and training-time optimizations, to further enhance model efficiency and performance.

According to one embodiment of the present invention, there is provided a system for training an artificial intelligence model over a training dataset comprising:
a processor configured to execute instructions;
a computer-readable medium containing instructions for execution on the processor, the instructions causing the processor to perform steps of:
partitioning the training dataset into a plurality of strata according to class labels, wherein each stratum represents a single label;
creating a subset data by selecting samples from each of the strata;
training the AI Model using the subset data until a first halting condition is reached; and
training the AI Mode using the training data set until a second halting condition is reached.

The subset data is created by selecting random samples from each stratum. In a preferred embodiment, the subset data is created by selecting samples based on ascending or descending informative ranking. The informative ranking of samples in each stratum is determined by first converting samples in each stratum into vectors and then organized to form the matrix with permutated matrix. The permutation matrix P can be chosen such that the diagonal elements of R are non-increasing: r₁₁≥r₂₂≥ . . . , ≥rₙₙ and P is a square binary matrix.

The halting condition or criteria are met when either a predefined convergence threshold is achieved, or the maximum number of epochs is reached.

In a preferred embodiment, the subset data is created by selecting a predetermined percent α of samples from each stratum. The percent α is between 10% to 50% or more particularly between 20% to 30%. The AI Model is a deep learning artificial neural network model, such as ResNet or DenseNet. The AI Model comprises the step of minimizing the loss function over the training data, either full set of data or subset of data. The AI model model parameters, such as weights and biases of neuron nodes for the AI neural network will be updated base on the loss function or other learning algorithm.

In a preferred embodiment, the method involves selecting samples from the subset data using QR factorization with column pivoting (QRCP) and subsequently utilizing the entire full dataset as training data. This approach enables the system 100 to use QRCP for pre-training sample selection, followed by fine-tuning with the full dataset.

In another embodiment, system 100 is adapted to conduct progressive pre-training. For example, it selects data samples in increments-starting with 20% for initial training, followed by continued training with 40%, then 60%, 80%, and finally 100% of the dataset. While this approach may not offer a significant advantage in efficiency when working with small datasets, it can be more effective for larger datasets, such as those with over 100 parameters or millions of data points. In one embodiment, the subset data is selected progressively from 20% to 100% adaptively for training based on size of an entire full dataset.

In comparison to other disclosed training methods with the present invention, those methods require extensive computational and time resources, particularly when using large datasets. The present invention novelly adds a phase in which only a subset of the entire training dataset is trained, subsequently followed by the traditional comprehensive training phase using the entire training dataset. Experimental results demonstrate that this subset pretraining strategy significantly decreases the total training time required by 50% to reach a predefined accuracy threshold. A detailed analysis of the methodology, experimental setup, and results, highlights the benefits of the present invention in the context of deep learning model training.

The subset pre-training method of the present invention comprises two main phases:
(i) initial training for a selected subset of the training dataset, and
(ii) comprehensive training in the full dataset.

The goal of this approach is to reduce overall training time while maintaining the accuracy of Details of the criteria for subset selection, training phases, hyperparameter tuning, and the expected theoretical benefits, such as faster convergence are described as follows.

### A. Subset Selection

Choosing a suitable subset of the training dataset is vital for the success of the suggested training method. In one embodiment, Stratified sampling serves as a beneficial technique for selecting this subset. It involves partitioning the training dataset into strata according to class labels, ensuring that samples are taken proportionately from each stratum to preserve the class distribution. In particular, it involves dividing the whole dataset D into k (for the labeled dataset, k could be the number of labels) non-overlapping strata (D₁, D₂, . . . , Dₖ), such that

$$\vert D \vert = {\sum }_{i = 1}^{k} \vert {D}_{i} \vert .$$

Then, each stratum Dᵢ, identified with the label i, is sampled independently using the following distinct methods for selecting subsets, each designed to improve the training efficiency of the ResNet/DenseNet models.

1. Random Sampling: A straightforward approach in which a random subset of the training data is selected. This method ensures diversity and representativeness across the dataset. The size of the subset can be defined as:

$$\vert {S}_{i} \vert = α \cdot \vert {D}_{i} \vert \qquad ( 1 )$$

where Dᵢ denotes the entire labeled i training dataset, Sᵢ is the selected subset from Dᵢ, and α is the percent indicator, which still needs to be adjusted. Random sampling is beneficial for quickly obtaining a diverse set of examples, which can help the model learn general features of the data.

2. QR decomposition for data sampling: QR decomposition is a factorization of a matrix:

$$X = Q R , \qquad ( 2 )$$

where Q is an orthogonal matrix (i.e., Q^{T}Q=I where I is the identity matrix) and R is an upper triangular matrix. Orthogonal Q ensures that each subsequent column vector represents a new direction that is not correlated with the previous ones. Thus, any noise or less significant components are naturally separated from the main signal, and more informative dimensions are focused on. Based on it, the upper triangular R encapsulates how much of the original data X can be represented along the orthogonal Q. The higher values of the diagonal entries of R indicate directions of greater variance, whereas the lower values imply less significance. Thus, the diagonal entries of R can often reflect the importance of each principal component or direction. Geometrically, Q can be viewed as a rotation or reflection of the data set in a multidimensional space. The transformation helps align the problem into a more solvable format by extracting essential features that highlight the structure of the data. This is the basis for QR decomposition to select important columns.

The pivoted version of QR decomposition utilizes a permutation matrix P indicating the reordering of columns of X:

$$X P = Q R . \qquad ( 3 )$$

P is usually chosen so that the diagonal elements of R are non-increasing: r₁₁≥r₂₂≥ . . . , ≥rₙₙ. Thus, the order helps prioritize the columns of X according to their significance or “informativeness”. To enhance both the representation and the computational efficiency, a more compact permutation array p can be used to achieve the same effect of rearranging columns instead of the permutation matrix P. For details on how the permutation array p corresponds to the permutation matrix P. The permutation matrix P is a square binary matrix that has exactly one entry of “1” in each row and each column with all other entries “0”, for example:

$${P}_{1} = [ \begin{matrix}0 & 0 & 1 \\ 1 & 0 & 0 \\ 0 & 1 & 0\end{matrix} ] or {P}_{2} = [ \begin{matrix}0 & 1 & 0 \\ 0 & 0 & 1 \\ 1 & 0 & 0\end{matrix} ]$$

For P₁, as “1” of the first column is in the 2 nd row, “1” of the second column is in the 3^{rd} row and “1” of the third column is in the 1^{st} row, the corresponding permutation array/vector is defined as p₁=[2 3 1]. Similarly, for P₂, since “1” of the first column is in the 3^{rd} row, “1” of the second column is in the 1^{st} row, and “1” of the third column is in the 2^{nd} row, the corresponding p₂=[3 1 2].

Accordingly, the ordered training data XP in (3) can be replaced by:

$${X}_{: , p} = QR \qquad ( 4 )$$

where the first column X_{:,p(1)} of X_{:,p} is the most informative column and the last column X_{:,p(|D|)} is the least informative column.

Therefore, to obtain the most informative α·|Dᵢ| samples from Dᵢ representing the label i, the server 100 should follow the steps: 1) All sample data from Dᵢ are directly converted into vectors and then organized to form the matrix Xⁱ. 2) The QR pivoting decomposition method is applied to rearrange the columns of Xⁱ, resulting in the ordered matrix

$${X}_{⋮ , p}^{i}$$

as depicted on the basis of equation (4). Then, the top informative α·|Dᵢ| samples subset is:

$${S}_{i}^{inf} = \{ {X}_{: , p ( 1 )}^{i} , {X}_{: , p ( 2 )}^{i} , … , {X}_{: , p ( a \vert {D}_{i} \vert )}^{i} \} \qquad ( 5 )$$

where

$${X}_{: , p ( j )}^{i}$$

denotes the j-th most informative sample. Alternatively, to obtain the least “value” or information regarding the underlying data structure, where the focus is on maximizing the data's relevance, then the samples are selected by:

$${S}_{i}^{less inf} = \{ {X}_{: , p ( \vert {D}_{i} \vert )}^{i} , {X}_{: , p ( \vert {D}_{i} \vert - 1 )}^{i} , … , {X}_{: , p ( \vert {D}_{i} \vert - α \vert {D}_{i} \vert + 1 )}^{i} \} \qquad ( 6 )$$

It is envisaged that other features can be included (appended) in columns of X to make the data more discriminative and sample selection for pre-training more effective. The feature extract method would be application dependent.

In one embodiment, Sobel edge detection and Gabor filtering are used to augment the data matrix X so that pivot ranking from QR decomposition can produce better results. They affect the permutation matrix P, but there is no direct relationship between P and Sobel edge detection and Gabor filtering.

In the QR decomposition process, samples are handled in a vectorized format, which typically means converting the original training data into column features. A standard method involves directly vectorizing the data to form columns, resulting in Xⁱ being derived in this manner. Additionally, features can also be derived using Sobel edge detection or a Gabor filtering, among other methods, and subsequently vectorized. The vectorized data are then organized into matrices Yⁱ or Zⁱ for ordering using QR pivoting decomposition:

$$\begin{matrix}{Y}^{i} {P}_{{Y}^{i}} = {Y}_{: , {p}_{{Y}^{i}}}^{i} = {Q}_{{Y}^{i}} {R}_{{Y}^{i}} \\ {Z}^{i} {P}_{{Z}^{i}} = {Z}_{: , {p}_{{Z}^{i}}}^{i} = {Q}_{{Z}^{i}} {R}_{{Z}^{i}}\end{matrix} \qquad ( 7 )$$

where the permutation vectors p_{Y}_{ⁱ} and p_{Z}_{ⁱ} obtained are associated with Sobel edge detection and Gabor filter respectively. Thus, the chosen subset of the training dataset based on Sobel edge detection (SE) and Gabor filter (G) may be any one or more of the following:

$$\begin{matrix}{S}_{i}^{inf\_SE} = \{ {X}_{: , {p}_{{Y}^{i}} ( 1 )}^{i} , {X}_{\cdot , {p}_{{Y}^{i}} ( 2 )}^{i} , … , {X}_{\cdot , {p}_{{Y}^{i}} ( α \vert {D}_{i} \vert )}^{i} \} , \\ {S}_{i}^{less inf\_SE} = \{ {X}_{: , {p}_{{Y}^{i}} ( \vert {D}_{i} \vert )}^{i} , {X}_{\cdot , {p}_{{Y}^{i}} ( \vert {D}_{i} \vert - 1 )}^{i} , … , {X}_{\cdot , {p}_{{Y}^{i}} ( \vert {D}_{i} \vert - α \vert {D}_{i} \vert + 1 )}^{i} \} , \\ {S}_{i}^{inf\_G} = \{ {X}_{: , {p}_{{Z}^{i}} ( 1 )}^{i} , {X}_{: , {p}_{{Z}^{i}} ( 2 )}^{i} , … , {X}_{\cdot , \cdot {p}_{{Z}^{i}} ( α \vert {D}_{i} \vert )}^{i} \} , \\ {S}_{i}^{less inf\_GE} = \{ {X}_{: , {p}_{{Z}^{i}} ( \vert {D}_{i} \vert )}^{i} , {X}_{: , {p}_{{Z}^{i}} ( \vert {D}_{i} \vert - 1 )}^{i} , … , {X}_{: , {p}_{{Z}^{i}} ( \vert {D}_{i} \vert - α \vert {D}_{i} \vert + 1 )}^{i} \} ,\end{matrix} \qquad ( 8 )$$

Another embodiment of the present invention could include exploring more feature extraction techniques. However, since only the permutation vectors p_{Y}_{ⁱ} and p_{Z}_{ⁱ} not the Yⁱ or Zⁱ in (7) serve as effective indices in (8), the permutation vectors from alternative feature extraction methodologies are used similarly as effective indices for Xⁱ in (8).

### B. Training Phase

The training procedure consists of two primary phases: initial training on the selected subset and comprehensive training on the full dataset. This structure promotes efficiency while ensuring that the model achieves high accuracy.

1. Initial training on the subset: The initial phase involves training the ResNet/DenseNet models using the selected subset S of the training data. This subset can be derived using methods such as Random Sampling

$$( {\{ {S}_{i} \}}_{i = 1}^{k}$$

in (1)), informative data sampling

$$( {\{ {S}_{i}^{inf} \}}_{i = 1}^{k}$$

in (5),

$${\{ {S}_{i}^{inf} SE \}}_{i = 1}^{k} and {\{ {S}_{i}^{inf G} \}}_{i = 1}^{k}$$

in (8)), or less informative data sampling

$$( {\{ {S}_{i}^{less inf} \}}_{i = 1}^{k}$$

in (6),

$$( {\{ {S}_{i}^{less inf\_SE} \}}_{i = 1}^{k} and {\{ {S}_{i}^{less inf\_G} \}}_{i = 1}^{k}$$

in (8)) as previously discussed. The training objective can be defined as minimizing the loss function [symbol] over the subset:

$$ℒ ( S ) = \frac{1}{\vert S \vert} {\sum }_{x ∈ S} ℒ ( f ( x ; θ ) , y ) \qquad ( 9 )$$

where f(x; θ) is the model's prediction, y is the true label, [symbol] denotes the loss function being optimized, and θ represents the model parameters. The key hyperparameters for this phase can include the fraction of the subset α in (1), the number of epochs E, and the learning rate Lᵣ. Training continues until a predefined criterion is met, such as a convergence threshold or maximum epochs.

In one embodiment of the present invention, the entire selected subset S is loaded in the local memory for initial training as the size of the selected subset S is significantly smaller.

2. Comprehensive training on the full dataset: Following initial training, the model undergoes comprehensive training using the full training dataset D. This phase refines the parameters learned from the initial training, allowing for better generalization. The loss function remains the same but is now evaluated over the entire dataset:

$$ℒ ( D ) = \frac{1}{\vert D \vert} {\sum }_{x ∈ D} ℒ ( f ( x ; θ ) , y ) \qquad ( 10 )$$

It is important that hyper-parameters (number of epochs E, and learning rate Lᵣ) tuning is conducted during this phase to ensure the model is optimally configured for the full dataset.

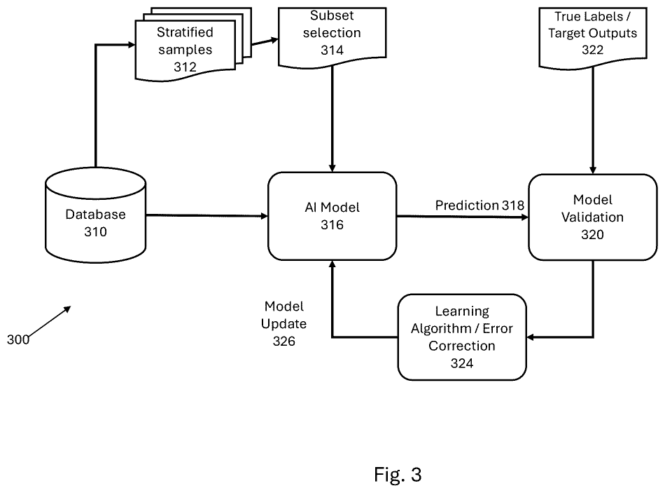

Using this two-phase approach, we anticipate several benefits, including faster convergence and reduced training time. The initial focus on a smaller subset allows for rapid iteration and adaptation of the model, while the subsequent comprehensive training utilizing the full dataset ensures robustness and accuracy. In addition, training on the subset allows the model to explore the parameter space more freely, reducing the risk of becoming trapped in local minima. Moreover, the subset selection strategy has the opportunity to improve the efficiency of training by allowing the model to learn from diverse or highly informative samples. Algorithm 1 gives the proposed method step by step and FIG. 2 shows a flowchart of the Subset Pre-Training Method and Original ResNet/DenseNet of system 300, as shown in FIG. 3.

Algorithm 1: The subset pre-training model

```
  Input: The training data of CIFAR10/CIFAR100 datasets D.
  1: Partition the training dataset into k strata according to class labels to
    $get {\{ {D}_{i} \}}_{i = 1}^{k} .$
  2: Select the subset of each stratum to create the dataset S. S is
    $exclusively one option among {\{ {S}_{i} \}}_{i = 1}^{k} in ( 1 ) , {\{ {S}_{i}^{inf} \}}_{i = 1}^{k} in ( 5 ) ,$
    ${\{ {S}_{i}^{less inf} \}}_{i = 1}^{k} in ( 6 ) , {\{ {S}_{i}^{inf\_SE} \}}_{i = 1}^{k} , {\{ {S}_{i}^{inf\_G} \}}_{i = 1}^{k} , {\{ {S}_{i}^{less inf\_SE} \}}_{i = 1}^{k} ,$
    ${\{ {S}_{i}^{less inf\_G} \}}_{i = 1}^{k} in ( 8 )$
  3: Train the subset S using classical ResNet/DenseNet until a predefined
    epoch count E is reached.
  4: Train the full dataset D with the trained parameters from step 3 until
    the state-of-the-art test accuracy is achieved. Then record the epoch
    count E′.
  Add together the epoch counts from step 3 to step 4 obtaining αE +
    E′
```

Referring to FIGS. 2 and 3, the AI system 300 of the present invention is adapted to carry out the steps of:
Step 202: start where the system 300 is adapted to load or retrieve the dataset from a database 310;
Step 204: the system 300 is adapted to stratify the dataset into strata 312 according to class labels such that each stratum preserves the class distribution;
Step 206: Each stratum Dᵢ, identified with the label i, is sampled independently to form a training subset 314;
Step 208: the system 300 passes the training subset 314 to the AI Model 316 for initial subset pre-training;
Step 210: the system 300 passes the entire dataset to the AI Model 316 for comprehensive full data set training;
Step 214: For each epoch in Step 208 or Step 210, the system 300 evaluates the AI model by comparing predicted results 318 with the model's prediction f(x; θ) with true labels or target outputs 322 in the model validation module 320. The module halts training when the halting condition is met. The halting conditions may be the loss function is less than a threshold or a number of epochs is reached. The learning algorithm module 324 computes the loss function [symbol] in (9) over the training data and updates the AI model 326 by adjusting model's parameters θ such as weights or biases of neuron nodes in order to minimize the loss function [symbol] during the training phase.

### C. Hyperparameter Tuning

Hyper-parameter tuning within this training framework is vital, as it directly impacts the model's ability to generalize from the training data.

In the subset pre-training process, the hyperparameter a needs to be experimentally validated to select an appropriate value. It should not be too small as it would fail to effectively achieve the purpose of introducing subset pre-training. In contrast, it should not be too large as the running time of each epoch is not small enough to reduce the training time. The epoch number E may also be predefined, not too small; also not too large, as it will make the parameters over fitting to the subset, thus reducing its effectiveness to train the entire data set. In one embodiment, the learning rate Lᵣ could be assigned according to the rule of the OneCycleLR function as it has the predefined epoch number E.

In the second stage (for complete training data) of an embodiment of the present invention, a test accuracy threshold may be used instead of a predefined number of epochs as the iterative stopping condition. This adjustment is made to prioritize the reduction of runtime upon achieving the specified test accuracy. Once the threshold is met, the iteration ceases, and the current number of epochs is recorded as the runtime. Thus, E′ here is just an upper bound. Additionally, the learning rate Lᵣ is configured as the step learning rate, consistent with traditional training processes for comparative assessment of time reduction.

### D. Faster Convergence

Faster convergence can be facilitated by reducing the amount of data processed. The main focus is the hyperparameter related to the subset α. With fewer samples, the model can iterate more quickly and identify optimal parameter configurations or settings earlier in the training process. This is the core principle of the present invention in the introduction of subset pre-training.

Proper tuning of other hyperparameters can also lead to faster convergence rates. For example, learning rates Lᵣ. However, to emphasize the significance of subset pre-training, the influence of learning rates is deliberately minimized. Consequently, these learning rates are adjusted for both subset pre-training and entire data training only according to fundamental requirements. The guidelines for setting them were detailed in the above paragraphs.

In summary, this structured training method of the present invention can maximize both efficiency and effectiveness, allowing for high-quality AI model training without compromising on resource expenditures. However, without careful attention to the adjustment of related variables/hyperparameters, these factors may become limitations or obstacles to the seamless implementation of this methodology.

### EXPERIMENT

In one embodiment of the present invention, a comprehensive experimental setup has been implemented to evaluate the performance of popular deep learning frameworks, including ResNet and DenseNet. These experiments were conducted using well-established datasets, including CIFAR10 and CIFAR100 datasets, and were performed on a standard desktop PC and a GPU P100, ensuring comparable hardware conditions. The deep learning AI models were trained using various versions of both TensorFlow and PyTorch to assess the impact of the accuracy and performance of the proposed model framework. An extensive methodology for performance evaluation was used, focusing on accuracy metrics and training duration. The results were analyzed using numerical indicators of performance variance between different model architectures to improve clarity and understanding of the findings.

### A. Hyperparameter Selection

In one embodiment, the system 300 is configured in order to identify optimal hyperparameter values for the well-known Resnet/DenseNet model, focusing specifically on the fraction of the training dataset (subset scale) represented by the variable a and the number of epochs E in the initial subset pretraining. Specifically, training the well-known ResNet on dataset CIFAR10 is taken as an example in the following part to explain how to choose α and E. To achieve the objective of the present invention, a hyperparameter grid search strategy that checks various configurations of the AI model will be implemented. The candidate values for α are selected from the set α={0.1,0.2,0.3,0.4,0.5}, representing different proportions of the training data to be used in the subset selection, while the number of epochs E in subset pre-training procedure will be obtained from the choices {10,20,30,50}.

The methodology starts with selecting a subset for the initial subset pre-training phase, followed by the comprehensive full dataset training phase. Then, two key performance metrics at the end of the comprehensive full dataset training phase are monitored: training time (number of epochs αE+E′ in the whole training process) and test accuracy. This systematic approach will enable us to delineate the effective hyperparameter settings for optimal performance of the ResNet model on the CIFAR10 dataset, enhancing the understanding of how varying these hyperparameters in the initial pre-training phase influences model performance of the present invention. Reference is made to Tables I, II and III for the results of α and E respectively. According to the results of the Tables, α=0.2/E=20, and α=0.3/E=10 perform well for training a ResNet model on the CIFAR10 dataset.

TABLE I
Initial Training Configuration: Impact of Random Subset
Fraction a and Epoch Count E on subset pre-training

| Training Time | | | | | | |
|---|---|---|---|---|---|---|
| (epochs) Test | | α | | | | |
| Accuracy (%) | | 0.1 | 0.2 | 0.3 | 0.4 | 0.5 |
| E | 10 | 31 | 16 | 15 | 17 | 16 |
| | | 90.83 | 91.16 | 91.01 | 91.33 | 91.07 |
| | 20 | 19 | 16 | 17 | 18 | 20 |
| | | 91.04 | 91.44 | 91.37 | 91.03 | 91.57 |
| | 30 | 20.4 | 17.6 | 19 | 22 | 25 |
| | | 91.18 | 91.27 | 91.13 | 91.21 | 91.62 |
| | 50 | 16 | 20 | 25 | 30 | 22 |
| | | 91.24 | 91.07 | 91.82 | 91.50 | 91.11 |

TABLE II
Initial Training Configuration: Impact of Informative Subset
Fraction a and Epoch Count E on subset pre-training

| Training Time | | | | | | |
|---|---|---|---|---|---|---|
| (epochs) Test | | α | | | | |
| Accuracy (%) | | 0.1 | 0.2 | 0.3 | 0.4 | 0.5 |
| E | 10 | 21 | 16 | 15 | 16 | 16 |
| | | 91.05 | 91.1 | 91.28 | 91.3 | 91.1 |
| | 20 | 21 | 15 | 17 | 18 | 20 |
| | | 91.24 | 91.21 | 91.36 | 91.26 | 91.46 |
| | 30 | 17 | 17 | 19 | 22 | 25 |
| | | 91.33 | 91.09 | 91.26 | 91.29 | 91.45 |
| | 50 | 16 | 20 | 25 | 30 | 35 |
| | | 91.19 | 91.11 | 91.47 | 91.71 | 91.77 |

TABLE III
Initial Training Configuration: Impact of Less Informative
Subset Fraction a and Epoch Count E on subset pre-training

| Training Time | | | | | | |
|---|---|---|---|---|---|---|
| (epochs) Test | | α | | | | |
| Accuracy (%) | | 0.1 | 0.2 | 0.3 | 0.4 | 0.5 |
| E | 10 | 21 | 21 | 17 | 16 | 18 |
| | | 91.03 | 91.11 | 91.50 | 91.05 | 91.25 |
| | 20 | 16 | 18 | 19 | 21 | |
| | | 91.12 | 91.33 | 91.2 | 91.23 | 91.29 |
| | 30 | 18 | 21 | 23 | 26 | |
| | | 91.15 | 91.3 | 91.31 | 91.26 | 91.47 |
| | 50 | 21 | 25 | 30 | 35 | |
| | | 91.34 | 91.18 | 91.2 | 91.4 | 91.64 |

### B. Subset Pre-Training on CIFAR10 by ResNet

One embodiment of the present invention implemented a rigorous evaluation of the proposed two-stage subset pre-training framework utilizing ResNet 18 for image classification on the CIFAR10 benchmark dataset. The experimental methodology begins with the Initial Training phase, where a subset is selected using stratified sampling, followed by random, informative, or less informative sampling methods to identify the relevant training subsets included in step 2 of algorithm 1.

For training data initialization, the system 300 is configured with the parameters batch_size=128, shuffle=True, and num_workers=2 and for test data initialization, the system has the configuration of batch_size=100, shuffle=False, and num_workers=2. The system 300 of this embodiment is configured to focus on several performance metrics to gauge effectiveness, including the overall training time for both phases combined (epoch number αE+E′) and the test accuracy achieved at the end of comprehensive full training phases. For subset selection, these multiple choices are inspired by the framework of ‘have not defined what ‘easy examples’ meant” in Curriculum Learning. The results are then summarized in Table IV. Once the target test accuracy of 92% is reached, the time savings for subset pre-training ResNet using various subset selection methods generally fall between 50% and 55%. Less informative subset based on Sobel edge extraction features leads to the most significant time reduction in Table IV, achieving a 50.2% decrease. In contrast, the other less informative subset pre-training techniques generally perform poorly. On the other hand, the informative subset pre-training methods consistently achieve time reduction between 51% and 52%.

TABLE IV
Performance of ResNet18 on CIFAR10 using Subset Pre-Training
Resnet

| | |
|---|---|
| Training Time (epochs) | 43 |
| Test Accuracy (%) | 92.47 |

Subset pre-training Resnet

| Sampling | | | | |
|---|---|---|---|---|
| style | | | | |
| Random | Training Time | 23 (53.4\%) | | |
| | (epochs) | | | |
| | Test Accuracy (%) | | | |
| | | features for QR | | |
| | | raw | sobel | gabor |
| | | image | edge | filter |
| Informative | Training Time | 22 | 22 | 22.3 |
| | (epochs) | (51.1%) | (51.1%) | (51.8%) |
| | Test Accuracy (%) | 92.44 | 92.40 | 92.42 |
| Less | Training Time | 23.6 | 21.6 | 26 |
| informative | (epochs) | (54.8%) | (50.2%) | (60.4%) |
| | Test Accuracy (%) | 92.48 | 92.30 | 92.32 |

### C. Subset Pre-Training on CIFAR100 By DenseNet

One embodiment of the present invention is adapted to assess the effectiveness of the subset pre-training framework applied to the CIFAR100 dataset using a lighter model architecture, specifically DenseNet. The AI Model training of this embodiment of the present invention will proceed using a two-phase approach, during which the hyperparameters are adjusted, including α and E, based on the insights gained from previous experiments. Performance metrics for this embodiment of the present invention will include test accuracy and training efficiency, compared to traditional training methods that do not employ subset selection. To facilitate data presentation, results will be illustrated through Table V in test accuracy and training time across the various training setups, providing the model's performance and efficiency.

Using this approach, it can be observed in Table V that the subset pre-training framework significantly cuts down the training time of DenseNet on the more intricate CIFAR100 dataset by approximately 49% to 53% relative to traditional training techniques. The most notable reduction in time achieved is 49.4% through the informative subset pre-training framework.

TABLE V
Performance of DenseNet on CIFAR100 using Subset Pre-Training
DenseNet

| | |
|---|---|
| Training Time | 122 |
| (epochs) | |
| Test Accuracy (%) | 75.16 |

Subset pre-training DenseNet

| Sampling style | | | | |
|---|---|---|---|---|
| Random | Training Time | 61.6(50.5%) | | |
| | (epochs) | | | |
| | Test Accuracy (%) | 75.10 | | |
| | | features for QR | | |
| | | raw | sobel | gabor |
| | | image | edge | filter |
| Informative | Training Time | 60.3 | 64 | 61 |
| | (epochs) | (49.4%) | (52.4%) | (50.0%) |
| | Test Accuracy (%) | 75.12 | 75.06 | 75.17 |
| Less | Training Time | 64.6 | 61 | 62.6 |
| informative | (epochs) | (52.9%) | (50.0%) | (51.3%) |
| | Test Accuracy (%) | 75.07 | 75.14 | 74.99 |

### CONCLUSION

The present invention introduces a novel subset pre-training methodology designed to significantly reduce the training time of deep neural networks, specifically ResNet/DenseNet, while maintaining model accuracy on test datasets. The traditional approach to training neural networks often requires extensive computational resources and time, particularly when dealing with large datasets. By implementing a two-phase training process of the present invention—training with a smaller subset of the training data before transitioning to full dataset training—the proposed approach demonstrates its effectiveness in accelerating convergence while achieving established accuracy benchmarks more efficiently.

The results of the present invention substantiate the efficacy of the subset pre-training approach, demonstrating a significant reduction in training duration while maintaining the desired accuracy on unseen data. The analysis provides a comprehensive overview of the methodological framework, including the selection process for the initial subset, the transition to full dataset training, and the evaluation metrics used to assess model performance.

In conclusion, the novel subset pre-training method and system of the present invention not only contributes to a reduction in training time but also maintains the integrity and performance of the neural network. Future work may explore the implementation of this methodology across various architectures and domains, potentially establishing a new standard for computational efficiency in deep learning practices. By emphasizing the importance of efficient training procedures, we hope to pave the way for further innovations in the field.

It will be understood by those skilled in the field that various modifications and alternatives can be made to the embodiments described above, without deviating from the overall scope of the present disclosure. These variations may include, but are not limited to, changes in specific implementations, configurations, or methodologies, provided that they remain within the general principles and objectives of the invention. Consequently, the embodiments provided should be regarded as exemplary rather than limiting, and any alterations that do not alter the core functionality and purpose of the invention are considered within the scope of the present disclosure.

1. A system for training an Artificial Intelligence Model over a training dataset comprising:
a processor configured to execute instructions;
a computer-readable medium containing instructions for execution on the processor, the instructions causing the processor to perform steps of:
partitioning the training dataset into a plurality of strata according to class labels, wherein each stratum represents a single label;
creating a subset data by selecting samples from each of the strata;
training the AI Model using the subset data until a first halting condition is reached; and
training the AI Mode using the training data set until a second halting condition is reached.

2. The system of claim 1, wherein the subset data is created by selecting a predetermined percent α of samples from each stratum.

3. The system of claim 2, wherein the subset data is created by selecting random samples from each stratum.

4. The system of claim 2, wherein the subset data is created by selecting samples based on informative ranking of samples in each stratum.

5. The system of claim 4, wherein the subset data is created by selecting samples based on ascending informative ranking.

6. The system of claim 4, wherein the subset data is created by selecting samples based on descending informative ranking.

7. The system of claim 4, wherein the informative ranking of samples in each stratum is determined by the steps of:
converting samples in each stratum into vectors and then organized to form the matrix Xⁱ;
performing QR pivoting decomposition method to rearrange columns of Xⁱ to obtain a matrix
$${X}_{⋮ , p}^{i} ,$$
such that XP=QR or X_{:,p}=QR wherein P is a square binary permutation matrix, Q is an orthogonal matrix, R is an upper triangular matrix, a first column X_{:,p(1)} of X_{:,p} is the most informative column and last column X_{:,p(|D|)} is the least informative column.

8. The system of claim 7, wherein P is chosen such that the diagonal elements of R are non-increasing: r₁₁≥r₂₂≥ . . . , ≥rₙₙ.

9. The system of claim 7, wherein the data matrix X includes Sobel edge detection results to enhance the input features.

10. The system of claim 7, wherein the data matrix X includes Gabor filtering results to enhance the input features.

11. The system of claim 1, wherein the first halting condition is reached when the AL Model has reached a convergence maximum epochs.

12. The system of claim 1, wherein the second halting condition is reached when the AL Model has reached a convergence threshold.

13. The system of claim 1, wherein the AI Model is a deep learning artificial neural network model.

14. The system of claim 1, wherein the steps of training the AI Model comprises the step of minimizing the loss function [symbol] over the subset, such that
$$ℒ ( S ) = \frac{1}{\vert S \vert} {\sum }_{x ∈ S} ℒ ( f ( x ; θ ) , y ) \qquad ( 9 )$$
wherein f(x; θ) is model's prediction, y is true label, [symbol] denotes the loss function being optimized, and θ represents the model parameters.

15. The system of claim 1, wherein the steps of training the AI Model comprises the step of selecting samples of the subset data based on the QR factorization with column pivoting and then use an entire full dataset as the training data set.

16. The system of claim 1, wherein the subset data is selected progressively from 20% to 100% adaptively based on size of an entire full dataset.
